(19) United States
(12) Patent Application Publication
(10) Pub. No.: US 2020/0404863 A1
(43) Pub. Date: Dec. 31, 2020

(54) LAYER FOR SUPPRESSING PERMEATION OF SOIL MOISTURE, GREENING SYSTEM, AND METHOD OF CONSTRUCTING GREENING SYSTEM

(71) Applicants: SUMITOMO RUBBER INDUSTRIES, LTD., Kobe-shi, Hyogo (JP); NATIONAL UNIVERSITY CORPORATION TOTTORI UNIVERSITY, Tottori-shi, Tottori (JP)

(72) Inventors: Kazuki NOJIRI, Kobe-shi, Hyogo (JP); Kenichi KURODA, Kobe-shi, Hyogo (JP); Haruyuki FUJIMAKI, Tottori-shi (JP); Iwao SAKAGUCHI, Tottori-shi (JP); Mitsuhiro INOUE, Tottori-shi (JP)

(73) Assignees: SUMITOMO RUBBER INDUSTRIES, LTD., Kobe-shi, Hyogo (JP); NATIONAL UNIVERSITY CORPORATION TOTTORI UNIVERSITY, Tottori-shi, Tottori (JP)

(21) Appl. No.: 16/976,867

(22) PCT Filed: Mar. 30, 2018
(86) PCT No.: PCT/JP2018/013748

§ 371 Date: Aug. 31, 2020

(51) Int. Cl. A01G 13/02; C09K 17/20; C08C 1/15

(52) U.S. Cl. CPC A01G 13/0275; A01G 13/0287; C08C 1/15; C09K 17/20

(57) ABSTRACT

An object of the present invention is to provide a layer for suppressing permeation of soil moisture that has a low environmental load and can be easily constructed, and a method of forming the same. The method of forming a layer for suppressing permeation of soil moisture comprises a step of spraying coagulant for a natural rubber latex over a target soil and then spraying a natural rubber latex over the target soil, and repeating the step twice or more.

### TECHNICAL FIELD

The present invention relates to a layer for suppressing permeation of soil moisture, a greening system in which the layer is constructed, and a method of constructing the greening system.

### BACKGROUND ART

Conventionally, as a method for securing soil moisture necessary for plant growth, a method of covering a soil surface with a film or sheet (Patent Document 1), a method of covering a soil surface with a mulching material having water-retaining property (Patent Document 2), etc. have been proposed. In addition, a method of burying a water-retaining material or the like in soil has also been proposed (Patent Documents 3 and 4).

### PRIOR ART DOCUMENT

### Patent Document

### Patent Document 1: JP H8-172939 A

### Patent Document 2: JP H11-243793 A

### Patent Document 3: JP S56-11722 A

### Patent Document 4: JP 2012-120485 A

### SUMMARY OF THE INVENTION

### Problem to be Solved by the Invention

However, the above-described method of securing soil moisture by covering the soil surface can suppress evaporation of soil moisture, but for sandy soil and the like such as those in a dry land, it cannot suppress permeation of moisture deep into the soil, leading to a problem of low utilization efficiency of irrigation or rainwater. In addition, the method of burying the water-retaining material or the like in soil can suppress permeation of moisture deep into the soil, but it has problems such as a large environmental load, difficulty in burying, and high cost.

### Means to Solve the Problem

An object of the present invention is to provide a layer for suppressing permeation of soil moisture that has a low environmental load and can be easily constructed, and a method of forming the same.

As a result of intensive studies, the present inventors have found that a permeation-suppressing layer composed of a natural rubber latex having a stable thickness can be conveniently formed by repeating a step of spraying coagulant for a natural rubber latex over a target soil and then spraying a natural rubber latex over the target soil twice or more, and completed the present invention.

That is, the present invention relates to

[1] A method of forming a layer for suppressing permeation of soil moisture, comprising a step of spraying coagulant for a natural rubber latex over a target soil and then spraying a natural rubber latex over the target soil, and repeating the step twice or more,

[2] The method of the above [1], wherein the amount of the natural rubber latex used is 300 to 2,000 g/m²,

[3] The method of the above [1] or [2], wherein the amount of the coagulant used relative to the amount of the natural rubber latex used (the amount of coagulant/the amount of the natural rubber latex) is 0.4 to 2.5,

[4] The method of any one of the above [1] to [3], wherein the coagulant is an organic acid and/or a lower alcohol,

[5] The method of any one of the above [1] to [4], wherein the layer has a thickness of 0.3 to 15.0 mm,

[6] A layer for suppressing permeation of soil moisture, formed by the method of any one of the above [1] to [5],

[7] A greening system, wherein the layer of the above [6] is constructed in the ground 3 to 300 cm below the soil surface, and

[8] A method of constructing a greening system comprising a covering step of covering the layer formed by the method of any one of the above [1] to [5] with a surface soil of 3 to 300 cm.

### Effects of the Invention

According to the present invention, a layer for suppressing permeation of soil moisture that has a low environmental load and can be easily constructed, a greening system in which the layer is constructed, and a method of constructing the greening system can be provided. The greening system in which the layer is constructed can efficiently utilize irrigated water or rainwater for plant growth.

### EMBODIMENT FOR CARRYING OUT THE INVENTION

### Method of Forming Permeation-Suppressing Layer

The layer for suppressing permeation of soil moisture, which is an embodiment of the present invention, is characterized by being a layer composed of a coagulated natural rubber latex and containing soil in the coagulated natural rubber latex with. Here, the “layer containing soil” means a layer composed of a natural rubber latex and soil such as that in a state where a natural rubber latex permeates a gap in soil to coagulate or a state of a sea-island structure where an island structure of soil exists in a sea structure composed of a coagulated natural rubber latex. By forming a layer having a low coefficient of permeability, which is composed of such natural rubber latex, between soil, an appropriate water-retaining capacity in soil can be maintained to an extent that root rot of plants does not occur.

A main component of the natural rubber latex is cis-1,4-isoprene, which is hydrophobic. Therefore, by forming a film of the natural rubber latex in soil, water permeating from the ground surface derived from rainwater or the like can be shut off, and water can be stored in soil above the film. In addition, when a natural rubber latex is used, unlike a case where a sheet such as vinyl chloride is laid or buried in soil, the natural rubber latex is decomposed into soil, so there is no need to recover and dispose of the natural rubber latex, and therefore, the environmental load can be reduced.

As a natural rubber latex, a raw latex (a field latex) collected from a rubber-producing plant, a concentrated natural rubber latex obtained by concentrating the field latex by removing proteins by a known concentration method such as centrifugation, or the like can be used. Examples of the concentrated natural rubber latex include a high ammonia natural rubber latex containing mainly ammonia as a preservative and a low ammonia natural rubber latex containing lauric acid or boric acid in addition to ammonia. Among them, the high ammonia natural rubber latex is preferable form the reason that it is not expensive and does not contain any chemical substances.

Normally, ammonia is added to latex as a bacterial proliferation inhibitor, since bacteria can proliferate and coagulate over time. However, tetramethylthiuram disulfide (TMTD) or zinc oxide is often added to a low ammonia natural rubber latex as an alternative to ammonia. TMTD has a high toxicity such as irritation to skin and eyes, allergic effect on skin, mutagenicity to microorganisms, and induction of a chromosomal aberration to a mammalian cell, and zinc oxide is also known to have an aquatic environmental toxicity. In the present embodiment, by using a high ammonia natural rubber latex, outflow of the-above-described harmful substances into the natural environment can be prevented and the environmental load can be reduced.

The permeation-suppressing layer according to the present embodiment is formed by repeating a step of spraying coagulant for a natural rubber latex over a target soil and then spraying a natural rubber latex over the target soil twice or more. After spraying in the order of coagulant and a natural rubber latex and forming a water-retaining film of the natural rubber latex on the soil surface, by further spraying in the order of coagulant and a natural rubber latex, a permeation-suppressing layer consisting of a natural rubber latex having a stable thickness can be conveniently formed. As such, according to the method of forming the layer for suppressing permeation of soil moisture relating to the present embodiment, a permeation-suppressing layer having a stable thickness can be conveniently formed regardless of soil properties, easily controlling the water-retaining capacity of soil.

On the other hand, in spraying in the order of a natural rubber latex and coagulant, the natural rubber latex sprayed first permeates the soil. And then, coagulant is sprayed, so coagulation starts from the ground surface side of the natural rubber latex sprayed first, and coagulant gradually permeates, to form a permeation-suppressing layer. In this case, since a rate of permeation of a natural rubber latex differs depending on the soil properties such as a soil composition and particle shape and size, it is necessary to adjust the spray amount and spray conditions depending on soil, which leads to a problem of complicated control of a layer thickness.

The total amount of the natural rubber latex used is appropriately adjusted according to the type of plant to be cultivated, etc., but it is preferably 300 g/m² or more, more preferably 500 g/m² or more, and further preferably 700 g/m² or more for the purpose of ensuring the amount of water to be stored. Furthermore, it is preferably 2,000 g/m² or less, more preferably 1,800 g/m² or less, and further preferably 1,600 g/m² or less, from the viewpoint of balance between water retention and drainage. When it exceeds 2,000 g/m², water content in soil becomes excessive, which may cause root rot of a plant.

A natural rubber latex solution is a natural product derived from a metabolic action of a plant, particularly preferably a natural rubber/water-based rubber in which a dispersion solvent is water. The concentration of the natural rubber latex solution is preferably 10% by mass or more, more preferably 15% by mass or more, and further preferably 20% by mass or more. When the concentration is less than 10% by mass, coagulation of the natural rubber latex does not progress, and a layer containing soil may not be formed. The concentration of the natural rubber latex solution is preferably 50% by mass or less, more preferably 40% by mass or less, and further preferably 30% by mass or less. When it exceeds 50% by mass, the cost becomes high, and a spraying equipment such as a spray becomes easily clogged.

Examples of coagulant include inorganic acids such as a hydrochloric acid, a nitric acid, a phosphoric acid, and a sulfuric acid; organic acids such as a formic acid, an acetic acid, a lactic acid, an oxalic acid, a malic acid, a tartaric acid, a succinic acid, a fumaric acid, a maleic acid, a citric acid, an ascorbic acid, a gluconic acid, and a glucuronic acid; sodium salts, potassium salts, magnesium salts, calcium salts, and aluminum salts thereof; lower alcohols such as methanol, ethanol, and isopropanol; and coagulants such as an anionic polymer coagulant, a cationic polymer coagulant, and a nonionic polymer coagulant. Among them, organic acids and lower alcohols are appropriately used, from the viewpoints of cost and ease of use. Coagulant can be used by being dissolved or suspended in a solvent, and examples of such a solvent include water and the like.

As an organic acid, those having a high solubility in water, a good decomposability, and a low health damage to users and a low environmental load are appropriately used. Examples of such an organic acid include C3-C7 hydroxy acids such as a lactic acid, a malic acid, a tartaric acid, and a citric acid, and among them, the citric acid is preferable. Furthermore, the environmental load can be reduced by a neutralizing action of ammonia derived from a high ammonia natural rubber latex with these organic acids, and ammonium salts of these organic acids produced by the neutralization reaction are also less harmful.

As a lower alcohol, a C1-C4 alcohol is preferable from the viewpoint of solubility in water, and ethanol is more preferable from the viewpoints of coagulation rate, volatility and the environmental load.

The total amount of coagulant used is preferably 300 g/m² or more, more preferably 500 g/m² or more, and further preferably 700 g/m² or more, from the viewpoint of coagulation rate of a natural rubber latex. Furthermore, it is preferably 2,000 g/m² or less, more preferably 1,800 g/m² or less, and further preferably 1,600 g/m² or less, from the viewpoints of cost and the environmental load.

When coagulant is a solid, it is preferably dissolved or suspended in a solvent before use. By dissolving or suspending coagulant in a solvent and then spraying it, coagulant can be uniformly sprayed over the entire ground surface, and the layer thickness of the permeation-suppressing layer can be made uniform. Although the concentration of coagulant in such a case varies depending on the type of coagulant, it is generally preferably in the range of 4.0 to 30.0% by mass.

For example, when an organic acid (preferably a C3-C7 hydroxy acid) is used as coagulant to use this as an aqueous solution, the concentration of the organic acid aqueous solution is preferably 4.0% by mass or more, more preferably 5.0% by mass or more, further preferably 7.0% by mass or more, and particularly preferably 9.0% by mass or more. When it is less than 4.0% by mass, coagulation of the natural rubber latex does not progress, and a layer containing soil may not be formed. On the other hand, the upper limit of the concentration of the organic acid aqueous solution is not particularly limited, but is preferably 30.0% by mass or less, more preferably 20.0% by mass or less, further preferably 18.0% by mass or less, and particularly preferably 15.0% by mass or less, from the viewpoints of cost and ease of preparation of the solution.

Furthermore, when a lower alcohol (preferably a C1-C4 alcohol) is used as coagulant to use this as an aqueous solution, the concentration of the alcohol aqueous solution is preferably 75% by mass or more, more preferably 90% by mass or more, further preferably 95% by mass or more, and particularly preferably 98% by mass or more. When it is less than 75% by mass, the coagulation rate of the natural rubber latex is slow, the natural rubber latex easily permeates the soil, and the layer thickness of the permeation-suppressing layer tends to be likely to vary depending on the soil properties.

Although the amount of coagulant used relative to the amount of the natural rubber latex (the amount of coagulant used/the amount of the natural rubber latex used) varies depending on the type of coagulant, it is generally preferably in the range of 0.4 to 2.5.

For example, when an organic acid (preferably a C3-C7 hydroxy acid) is used as coagulant, the amount of coagulant used relative to the amount of the natural rubber latex (the amount of coagulant/the amount of the natural rubber latex used) is preferably 0.4 or more, more preferably 0.6 or more, and further preferably 0.8 or more. When it is less than 0.4, the coagulation rate of the natural rubber latex is slow, the natural rubber latex easily permeates the soil, and the layer thickness of the permeation-suppressing layer tends to be likely to vary depending on the soil properties. On the other hand, it is preferably 2.5 or less, more preferably 2.0 or less, and further preferably 1.5 or less. When it exceeds 2.5, the amount of the natural rubber latex is too small, which may make it difficult to form a continuous permeation-suppressing layer.

The layer thickness of the permeation-suppressing layer is preferably 0.3 mm or more, more preferably 1.0 mm or more, further preferably 2.0 mm or more, and particularly preferably 2.5 mm or more, for the purpose of ensuring the amount of water to be stored. Furthermore, it is preferably 15.0 mm or less, more preferably 10.0 mm or less, and further preferably 8.0 mm or less, from the viewpoint of balance between water retention and drainage. In order to set the layer thickness of the permeation-suppressing layer within the above-described ranges, a step of spraying coagulant and then spraying a natural rubber latex can be repeated twice or more to arbitrary number of times, preferably 2 to 10 times, and more preferably 2 to 5 times.

Although each spray interval between coagulant and the natural rubber latex is not particularly limited, but it is preferably about 1 minute. For example, when the spray interval between coagulant which is first sprayed and the natural rubber latex under a high temperature environment is increased and coagulant is a lower alcohol, the lower alcohol can volatilize before the natural rubber latex is sprayed, and it becomes difficult to coagulate the natural rubber latex. Furthermore, when coagulant is an organic acid aqueous solution, water content evaporates before the natural rubber latex is sprayed, and the solid coagulant remains in the ground, but the coagulation rate of the natural rubber latex becomes slower than when the organic acid aqueous solution is used, and thus it becomes difficult to make the layer thickness of the permeation-suppressing layer uniform.

The amount of coagulant and the natural rubber latex sprayed each time may or may not be equal, but it is preferable to gradually increase the spray amount each time. After spraying in the order of a small amount of coagulant first and the natural rubber latex to form a water-retaining film of the natural rubber latex on the soil surface, by gradually increasing the amount of coagulant and the natural rubber latex sprayed, a permeation-suppressing layer having a stable thickness can be formed. When the amount of coagulant sprayed first is large, coagulant can permeate deep into the soil and thus become wasted. In addition, since the amount of coagulant near the ground surface is insufficient and the latex sprayed thereafter does not sufficiently coagulate, it becomes difficult to make the layer thickness of the permeation-suppressing layer uniform.

### Greening System

The greening system according to an embodiment of the present invention is characterized in that the above-described permeation-suppressing layer is buried in the ground. According to this greening system, since it has a permeation-suppressing layer composed of a natural rubber latex in the ground, permeation of irrigation water or rainwater deep into the soil can be suppressed, and soil moisture can be secured. Therefore, by planting a plant on the permeation-suppressing layer, water content necessary for plant growth can be secured. In particular, in areas where it is difficult for plants to grow such as an area where soil is sandy and an area where there is little rainfall, an environment, in which plants can grow, can be prepared by utilizing the greening system.

The depth from the soil surface on which the permeation-suppressing layer is constructed can be appropriately adjusted depending on a plant to be cultivated, etc., to be preferably 3 to 300 cm, more preferably 5 to 200 cm, and further preferably 10 to 100 cm. When it is shallower than 3 cm, there is little soil which can secure water content, which is insufficient for plant growth. When it is deeper than 300 cm, the construction tends to become difficult. In addition, a plant cultivated by utilizing the above-described greening system is not particularly limited.

A method of cultivating a plant is also not particularly limited, and a plant can be cultivated by a conventional method. Furthermore, the above-described greening system can comprise a device included in a normal greening system, such as an irrigation device, in addition to the permeation-suppressing layer.

### Method of Constructing Greening System

The permeation-suppressing layer according to the present embodiment can be easily formed in a short time by spraying a solution of coagulant and a natural rubber latex with a commonly used pesticide sprayer on the exposed underground soil. Thus, the greening system according to the present embodiment does not require the use of special equipment or heavy equipment unlike a case where a heavy object such as a sheet is stretched around, and therefore it can be easily constructed even in remote areas such as a dry land.

The method of constructing the permeation-suppressing layer includes a method of constructing a greening system, comprising an exposure step of removing a surface soil in a target site for the construction and exposing the underground soil; a step of forming a layer for suppressing permeation of soil moisture, characterized by including a step of spraying coagulant for a natural rubber latex and then a natural rubber latex on the exposed soil surface and repeating the step twice or more; and a step of covering the formed layer with the removed surface soil.

The above-described exposure step is a step of removing a surface soil in a target site for the construction to a depth where a water-retaining film is constructed and exposing the underground soil. A method of removing a surface soil is not particularly limited, and a conventional method can be adopted depending on the depth and area.

The above-described step of forming the permeation-suppressing layer can adopt the above-described method.

The above-described covering step is a step of covering the permeation-suppressing layer with the removed surface soil. The covering method is not particularly limited, and a conventional method can be adopted depending on the amount and area of the surface soil. When the covering step is performed, a coagulation state of the permeation-suppressing layer is not particularly limited, and the covering step may be performed during the coagulation.

### EXAMPLE

The present invention will be described based on examples, but the present invention is not limited to the examples.

Hereinafter, various materials used in Examples and Comparative examples will be collectively shown.

Citric acid aqueous solution: a citric acid aqueous solution obtained by dissolving an anhydrous citric acid manufactured by Yoneyama Yakuhin Kogyo Co., Ltd. in ultrapure water (Milli-Q water) to have a predetermined concentration was used.

Ethanol: 99.5% of ethanol manufactured by Ueno Fine Chemicals Industry, Ltd. was used.

Natural rubber latex: a natural rubber latex obtained by diluting a high ammonia natural rubber latex HYTEX-HA manufactured by Nomura Trading Co., Ltd. with ultrapure water (Milli-Q water) to a predetermined concentration and filtering it with a nylon mesh (200 mesh) was used.

Sand 1: Toyoura standard sand manufactured by Toyoura Keiseki Kogyo Co., Ltd. (average particle size: about 0.2 mm) was used.

Sand 2: Sand obtained by removing organic substances from sand in the field in Arid Land Research Center, Tottori University (average particle size: about 0.4 mm) was used.

### Examples and Comparative Examples

Sand was filled in a vat having a vertical length of 200 mm, a lateral length of 250 mm, and a depth of 500 mm and smoothed by a metal plate having a surface length of 300 mm, a width 30 mm, and a thickness of 1 mm. Then, coagulant and a natural rubber latex were sprayed by a shoulder type manual sprayer SS-5P manufactured by KOSHIN LTD. in the spray amounts and orders shown in Tables 1 and 2. After forming a water-retaining film, the vat was dried in an electric furnace at 80° C. for 12 hours. Besides, in the spraying methods of Tables 1 and 2, the citric acid aqueous solution and ethanol were described as “coagulant”, and the natural rubber latex was described as “latex”.

### Measuring Layer Thickness of Permeation-Suppressing Layer

The formed permeation-suppressing layer was peeled off from the vat, and the central part of the layer was cut out into 50 mm square. Using a microscope VHX-5000 manufactured by KEYENCE CORPORATION, the thicknesses of the central part of each square is measured, and the average value of the measured thickness was considered as a layer thickness of the permeation-suppressing layer.

TABLE 1

| | | Example 1 | Example 2 | Example 3 | Example 4 | Example 5 |
|---|---|---|---|---|---|---|
| Citric acid | Concentration | 10 | 10 | 5 | 10 | — |
| aqueous | (%) | | | | | |
| solution | Spray amount | 1.5 | 1.5 | 1.5 | 1.0 | — |
| | (kg/m²) | | | | | |
| Ethanol | Spray amount | — | — | — | — | 1.5 |
| | (kg/m²) | | | | | |
| Natural | Concentration | 30 | 30 | 30 | 30 | 30 |
| rubber | (%) | | | | | |
| latex | Spray amount | 1.5 | 1.5 | 1.5 | 1.0 | 1.5 |
| | (kg/m²) | | | | | |
| Spraying method | | (0.5 kg/m² of | 0.5 kg/m² of | (0.5 kg/m² of | (0.5 kg/m² of | (0.5 kg/m² of |
| | | coagulant → | coagulant → | coagulant → | coagulant → | coagulant → |
| | | 0.5 kg/m² of | 0.5 kg/m² of | 0.5 kg/m² of | 0.5 kg/m² of | 0.5 kg/m² of |
| | | latex) × 3 | latex → 1 kg/m² | latex) × 3 | latex) × | latex) × 3 |
| | | times | of coagulant → | times | twice | times |
| | | | 1 kg/m² of | | | |
| | | | latex | | | |
| Layer | Sand 1 | 4.0 | 4.1 | 4.2 | 2.7 | 6.2 |
| thickness | Sand 2 | 4.1 | 4.3 | 4.4 | 2.8 | 6.5 |
| (mm) | | | | | | |

| | | | | | |
|---|---|---|---|---|---|
| Difference in layer | 0.1 | 0.2 | 0.2 | 0.1 | 0.3 |
| thickness (mm) | | | | | |

TABLE 2

| | | Comparative | Comparative | Comparative | Comparative |
|---|---|---|---|---|---|
| | | example 1 | example 2 | example 3 | example 4 |
| Citric acid | Concentration (%) | 10 | 10 | 5 | — |
| aqueous | Spray amount | 1.5 | 1.5 | 1.5 | — |
| solution | (kg/m²) | | | | |
| Ethanol | Spray amount | — | — | — | 1.5 |
| | (kg/m²) | | | | |
| Natural | Concentration (%) | 30 | 30 | 30 | 30 |
| rubber latex | Spray amount | 1.5 | 1.5 | 1.5 | 1.5 |
| | (kg/m²) | | | | |
| Spraying method | | 1.5 kg/m² of | 1.5 kg/m² of | 1.5 kg/m² of | 1.5 kg/m² of |
| | | latex → | coagulant → | coagulant → | coagulant → |
| | | 1.5 kg/m² of | 1.5 g/m² of | 1.5 kg/m² of | 1.5 kg/m² of |
| | | coagulant | latex | latex | latex |
| Layer | Sand 1 | 9.2 | 5.2 | 5.5 | 7.8 |
| thickness | Sand 2 | 14.6 | 8.3 | 8.7 | 12.8 |
| (mm) | | | | | |

| | | | | |
|---|---|---|---|---|
| Difference in layer thickness (mm) | 5.4 | 3.1 | 3.2 | 5.0 |

From the results of Tables 1 and 2, it can be found that a permeation-suppressing layer having a stable thickness can be conveniently formed regardless of the soil properties, according to the method of forming the layer for suppressing permeation of soil moisture relating to the present invention.

### INDUSTRIAL APPLICABILITY

The layer for suppressing permeation of soil moisture according to the present invention, which is composed of a coagulated natural rubber latex, is good in water-retaining capacity, has a small environmental load, and can be easily constructed, so that it is particularly useful in constructing a greening system in remote areas such as a dry land.

1. A method of forming a layer for suppressing permeation of soil moisture, comprising a step of spraying coagulant for a natural rubber latex over a target soil and then spraying a natural rubber latex over the target soil, and repeating the step twice or more.

2. The method of claim 1, wherein the amount of the natural rubber latex used is 300 to 2,000 g/m².

3. The method of claim 1, wherein the amount of the coagulant used relative to the amount of the natural rubber latex used (the amount of coagulant/the amount of the natural rubber latex) is 0.4 to 2.5.

4. The method of claim 1, wherein the coagulant is an organic acid and/or a lower alcohol.

5. The method of claim 1, wherein the layer has a thickness of 0.3 to 15.0 mm.

6. A layer for suppressing permeation of soil moisture, formed by the method of claim 1.

7. A greening system, wherein the layer of claim 6 is constructed in the ground 3 to 300 cm below the soil surface.

8. A method of constructing a greening system comprising a covering step of covering the layer formed by the method of claim 1 with a surface soil of 3 to 300 cm.
